(19) United States
(12) Patent Application Publication
(10) Pub. No.: US 2026/0156440 A1
(43) Pub. Date: Jun. 4, 2026

(54) Wireless monitoring system

(71) Applicant: Changdu Liren Electric Co., Ltd, Chengdu (CN)

(72) Inventor: Yuanjian Li, Chengdu (CN)

(21) Appl. No.: 19/258,822

(22) Filed: Jul. 2, 2025

(51) Int. Cl. H04W 4/80

(52) U.S. Cl. CPC H04W 4/80

(57) ABSTRACT

A wireless monitoring system includes: a wireless sensor, a sensor gateway, a patient transmitter and a nurse transmitter; wherein the wireless sensor includes a pressure sensor, a first wireless transceiver, a BLE tag having a BLE wireless transceiver, a magnetic field sensor and a communication controller; the sensor gateway includes a gateway communication controller, a BLE reader, a second wireless transceiver, a sensor controller, a third wireless transceiver, a fourth wireless transceiver, and a magnetic field generator; the patient transmitter includes a patient BLE tag communicating with the BLE reader; and the nurse transmitter includes a nurse BLE tag communicating with the BLE reader. The wireless monitoring system uses initial wireless communication channel assignment algorithm to improve the stability and reliability of the wireless communication system composed of wireless sensors and wireless monitors.

### BACKGROUND OF THE PRESENT INVENTION

### Field of Invention

The present invention relates to the technical field of wireless communication system, and more particularly to a wireless monitoring system

### Description of Related Arts

Wireless fall monitoring system belongs to the wireless communication system composed of wireless sensors and wireless monitors, which is mainly used in hospitals and nursing homes to monitor the behavior of the elderly or patients who leave their beds alone without being accompanied by nursing staff, and sends out alerts to the nursing staff, so that they can go to the wards for nursing care in time to prevent the occurrence of falls. In this field, Smart's patent U.S. Pat. No. 7,924,163B1 and Posey's patent US 20240074677 A1, U.S. Pat. No. 11,776,374B2 provide wireless monitoring system consisting of wireless pressure sensor pads installed in beds, and wireless monitors. When the patient leaves the wireless pressure sensor pad, the wireless pressure sensor pad sends a wireless alarm signal to the wireless monitor. The wireless monitor receives the wireless alarm signal, enters the alarm state, and issues an alarm to remind the nurse to go to the ward for care. This process involves wireless signal transmission. The wireless signal may be interfered with, including from similar wireless pressure sensor pads, when multiple wireless pressure sensor pads simultaneously detect that the patient has left the sensor pad or that the patient has briefly left the sensor pad due to turning over, and send wireless alarm signals to the wireless monitor at the same time. Especially if the transmitters of the wireless sensor pads use the same wireless channel, radio interference may occur, thereby affecting the reliability of wireless signal transmission. This leads to the wireless monitor being unable to reliably receive the wireless alarm signal. Therefore, the stability and reliability of the wireless communication system composed of wireless sensors and wireless monitors is extremely important, which determines the safety of patients. Usually, compared with the wired system, the stability and reliability of the wireless system is at a disadvantage, especially for the hospital having wards in the same area or floor, there will be hundreds or even thousands of wireless sensors. Co-channel interference caused by transmitters of the wireless sensors is the main factor affecting the stability and reliability of wireless communication. Although in the patents of smart and Posey, it is mentioned that wireless communication systems including multiple wireless communication channels such as frequency-hopping communication or spread spectrum communication, and Bluetooth communication are adopted to improve the reliability of communication, Although they have multiple wireless communication channels, for example, Bluetooth has dozens of wireless communication channels, However, they did not set a different initial wireless communication channel for each wireless sensor. All the wireless sensors still used the same initial wireless communication channel. This led to a large communication traffic in this initial communication channel, which was very prone to co-frequency interference, communication delay, or even communication blockage due to excessive communication traffic during a certain period while other communication channels were in an idle state with very small or almost zero communication traffic. A large number of wireless sensors do not make full use of multiple channel resources for multi-channel communication. Instead, they are crowded in the same initial wireless communication channel for communication. Switch to other wireless communication channels only when communication interference occurs. The present invention allocates a dedicated Initial wireless communication channel to the transmitter of each wireless sensor pads, so that the wireless communication traffic of a large number of wireless sensors can be evenly distributed across all available wireless communication channels, making full use of the resources of the wireless channels, and reduce the wireless communication traffic of each wireless communication channel. It reduces the radio interference among the transmitters of multiple wireless sensor pads, improving the stability and reliability of communication.

In the hospital bed, patient will turn over and remove the body weight away from the pressure sensor, resulting in a pressure-free state of the sensor for a short period of time (usually 1-3 seconds). This pressure-free state will be sensed as “out of bed” (the patient has left the bed), while the actual situation is that the patient is still in the bed, but just turning over. According to Smart's patent, at this time, the wireless sensor pad will send a signal to the sensor pad receiver, indicating that the patient has got out of bed and in turn triggering a false alert. False alerts will cause additional burden and disturbance to the work of nursing staff, increasing the care cost in hospitals. Furthermore, frequent “cry wolf” will affect the ability of the nursing staff to timely reacts on real alert signals.

Conventional wireless monitoring system can provide the alert of the patient leaving the bed, which is transmitted to the nurse station through the patient station and displayed as a calling state. Since the call button and the alert share the same port of the patient station, the display at the nurse station can only show that the ward is in a calling state, and it is impossible to distinguish whether the call display at the nurse station is from the monitor's fall alert or from the call button, which causes troubles for the nurses to make the judgment of whether it needs an emergent response or not. Not being able to tell whether the call display at the nurse station is a calling request for a cup of coffee or a fall alert puts the nurses in a state of chronic stress and fatigue, which reduces their work efficiency. The inability to respond quickly to real alerts after repeated experiences of cry wolf reduces the effectiveness of the monitoring system in reducing the incidence of falls. Moreover, the display at the nurse station can only show the “call”, but cannot provide more information about the patient in the ward, such as whether the patient is in the ward, in bed, on a chair or on a toilet, and whether the patient's body posture in bed is, for example, flat, on side or unchanged for too long, which is a situation that may lead to bedsores, it is necessary for nurse to assist in changing body postures. The present invention adopts a sensor gateways that provide data for wireless smart devices, such as the smart phones used by nurses, can offer more information than the displays in nurse stations, in particular, it can distinguish between alarm status and call status, helping nurses respond promptly to the alarm of patients leaving the bed, reducing the occurrence of patients falling, relieving the pressure on nursing staff, and improving work efficiency. It can remind nurses to assist patients in turning over in time to prevent the occurrence of bedsores too.

Posey's patent uses NFC proximity communication wireless chips to enable close pairing between wireless sensors and wireless monitors. This method is very convenient for healthcare workers, but requires that the NFC wireless communication chip in the sensor and the MCU in the sensor adapter of both wireless sensor and wireless monitor are always in the working state and cannot be in a low-power standby state, which results in a continuous working current consumption of the battery-powered transmitter reaching the milliampere level, and requires a relatively large-capacity battery for power supply. Moreover, the use of an additional NFC wireless communication chip for wireless pairing increases the cost of the wireless sensor. The present invention adopts a reed switch and a magnetic field generator to achieve a close to pairing between wireless sensors and wireless monitors similar to Posey's patent, reducing the current consumption of the transmitter before pairing to the microampere level. The transmitter can use a battery with a smaller capacity and low-cost reed switch, reducing the cost of the product.

The data logger in the sensor gateway has multiple important values for the operation and management of hospitals. By continuously recording the status information of wireless sensors and alarm devices (such as standby, monitoring, alarm, etc.), the timestamp recording function ensures that patient monitoring is not interrupted, providing objective evidence for medical disputes and clarifying the division of responsibilities. The historical record of the rapid response alarm status for critical events helps analyze the timeliness of alarm responses. The operation log can trace whether the medical staff's handling process of the alarm complies with the norms. The error information record (such as sensor connection failure) can identify the vulnerable links of the system. The complete status change record meets the regulatory compliance requirements for medical devices. Provide an immutable electronic evidence chain for the investigation of medical malpractice.

Nurses often need to move the patients in the bed to the outside of the ward for examination or treatment, and the wireless monitor is installed in the ward. When the patient's bed leaves the ward, the sensor installed on the patient's bed, the BLE reader failed to receive the sensor signal within the set time due to the long distance, which triggers the wireless monitor in the ward to send out a sensor loss alert, and it is necessary to go to the ward to reset the alert of the wireless monitor, which causes troubles for Care giver.

When the nurse goes to the ward to respond to an alert triggered by a patient leaving the bed, she needs to press the reset button on the alert device to reset it. During the nursing care of the patient, in order to avoid triggering the sensor again, the nurse also needs to press a hold button to make the alert in a hold standby state. All these operations are very cumbersome, affecting nursing efficiency.

Conventional alert devices in the art are only capable of detecting disconnection between the alert port and the cable connecting the patient station, but cannot detect disconnection between the cable and the patient station port, which results in a dangerous condition where the alert signal cannot be output to the patient station because of the disconnection of the patient station port, resulting in alert at nurse station failure.

### SUMMARY OF THE PRESENT INVENTION

An object of the present invention is to provide a wireless monitoring system, thereby overcoming the above defects.

Accordingly, in order to accomplish the above object, the present invention provides:
A wireless monitoring system, comprising:
   a wireless sensor, comprising a pressure sensor (1) and a sensor transmitter; wherein the sensor transmitter comprises a first wireless transceiver (2), a BLE (Bluetooth Low Energy) tag (3) having a BLE wireless transceiver (4), a magnetic field sensor (5) and a communication controller (6); wherein the pressure sensor (1), the first wireless transceiver (2), the BLE tag (3) and an output of the magnetic field sensor (5) are connected to the communication controller (6); the communication controller comprises a communication controller MCU (Microcontroller Unit) (7) and a communication controller memory (8) containing an embedded program for a communication protocol; the communication controller (6) controls a bidirectional wireless communication between the first wireless transceiver (2) and a second wireless transceiver (9), as well as controls a wireless communication between the BLE wireless transceiver (4) and a BLE reader (10);
   a sensor gateway, comprising a gateway communication controller (11), the BLE reader (10) having a wireless transceiver module, the second wireless transceiver (9), a sensor controller (12), a third wireless transceiver (13), a fourth wireless transceiver (14), and a magnetic field generator (15); wherein the second wireless transceiver (9), the BLE reader (10), the third wireless transceiver (13) and the fourth wireless transceiver (14) are connected to the gateway communication controller (11) and the sensor controller (12), respectively; the sensor controller (12) comprises a timer (16), and provides an operator interface (39) for setting or modifying an initial value of the timer (16); the gateway communication controller (11) comprises a gateway MCU (17) and a gateway memory (18) containing the embedded program for the communication protocol; the gateway communication controller (11) and the sensor controller (12) communicates with each other; the gateway communication controller (11) controls a communication between the first wireless transceiver (2) and the second wireless transceiver (9), controls the wireless communication between the BLE wireless transceiver (4) and the BLE reader (10), controls a wireless communication between the third wireless transceiver (13) and a router (32), and controls a wireless communication between the fourth wireless transceiver (14) and a wireless alert device (19); the magnetic field generator (15) is arranged on the sensor gateway, and the magnetic field sensor (5) of the wireless sensor detects a magnetic field of the magnetic field generator (15);
   a patient transmitter, comprising a patient BLE tag (21) communicating with the BLE reader (10), which periodically sends information containing a code representing a risk level of a patient and a unique ID of the patient transmitter to the BLE reader (10); and
   a nurse transmitter, comprising a nurse BLE tag (22) communicating with the BLE reader (10), which periodically sends information containing unique ID of the nurse transmitter to the BLE reader (10).

Preferably, the sensor controller (12) is connected to a wired alert device (20), so as to output an alert signal to the wired alert device (20); the wired alert device (20) and the sensor gateway are arranged in a same shell to form a wireless fall monitor.

Alternatively, the wired alert device (20) and the sensor gateway are arranged in different shells to form a split wireless fall monitor through wireless communication.

Preferably, the sensor gateway further comprises a display interface (The controller for visual indicator) and a visual indicator; wherein the visual indicator is an LED, LCD or E paper display, for displaying desired information such as sensor locations, as well as operating status of sensors and the sensor gateway; the sensor gateway further comprises an operating interface such as a switch button to accomplish a desired operation, such as resetting the alert.

Preferably, the wireless sensor is a wireless sensor, which is configured to be placed on a bed, a sofa, a chair, a wheelchair or a toilet.

Preferably, the wireless alert device (19) communicates with the fourth wireless transceiver (14) to receive a wireless alert signal from the sensor controller (12).

Preferably, under control of the gateway communication controller, a wireless patient station receiver (23) communicates with the second wireless transceiver (9) to receive a wireless alert signal from the sensor controller (12), and then sends the wireless alert signal to a patient station (24).

Preferably, a ward wireless alert device (25) communicates with the second wireless transceiver (9) to receive a wireless alert signal from the sensor controller (12).

Preferably, the pressure sensor (1) is a pressure sensitive switch sensor; a pressure sensing circuit of the pressure sensor (1) comprises an upper conductive film (26), a lower conductive film (27), and an elastic isolation layer (28); wherein the elastic isolation layer (28) is perforated; the upper conductive film (26) and the lower conductive film (27) are isolated from each other by the elastic isolation layer (28). The upper conductive film (26) and the lower conductive film (27) corresponds to two electrodes of a pressure sensitive switch. The pressure sensor (1) also comprises two output electrode slices that are connected to the upper conductive film (26) and the lower conductive film (27). When the patient's body is pressed on the top of the bed pressure sensor, the upper conductive film is pressurized and deformed, so as to contact the lower conductive film through perforated holes (38) on the elastic isolation layer. At this time, the pressure sensitive switch is turned on, and the two output electrode slices output ON. That is to say, the pressure sensor detects the pressure and outputs a corresponding ON signal or the switch status data output by the pressure sensor (1) is ON. When the patient's body is not on the top of the bed pressure sensor, the upper conductive film is restored to flatness, and is isolated from the lower conductive film by the elastic isolation layer. At this time, the pressure sensitive switch is turned off, and the two output electrode slices output OFF. That is to say, the pressure sensor does not detect the pressure and outputs a corresponding OFF signal or the switch status data output by the pressure sensor (1) is OFF. The two output electrode slices of the pressure sensor are connected to two inputs of the communication controller (6) of the wireless sensor, respectively. In addition to the wireless pressure sensor for the hospital bed, the system can also comprise wireless pressure sensors for bedside chairs, toilets, seat belts and other locations, as long as the pressure generated by the patient's body weight can be detected.

Preferably, the communication controller (6) of the wireless sensor is connected to the pressure sensor (1), and the MCU (7) of the communication controller (6) collects switch status data output by the pressure sensor (1), and periodically transmits information containing unique ID of said sensor transmitter and the switch status data to the BLE reader (10) through the BLE wireless transceiver (4) of the BLE tag (3) at a fixed period; and then the BLE reader (10) transmits the switching state data to the third wireless transceiver (13); the third wireless transceiver (13) transmits the switching state data along with an alert signal and a reset signal output by the sensor controller (12) to the router (32); the router (32) transmits the switching state data, the alert signal and the reset signal to a network server (29). The sensor gateway also communicates with a cloud server via a TCP/IP protocol to transmit the switching state data, the alert signal and the reset signal data to the cloud server.

Preferably, the fixed period is 0.5-15 seconds.

When the BLE reader (10) does not receive the switch status data transmitted from the BLE wireless transceiver (4) of the BLE tag (3) to the BLE reader (10) after one fixed period, the sensor gateway outputs a sensor lost signal and an alert signal.

Preferably, the fourth wireless transceiver comprises a Bluetooth transceiver (30), and the Bluetooth transceiver (30) transmits the switching state data, the alert signal and the reset signal to a wireless smart device (31) or the wireless alert device (19). The wireless smart device can be a cell phone or a tablet.

According to the present invention, due to the BLE wireless transceiver of the BLE tag of the wireless sensor transmits the switching state data in a fixed period (for example, the period can be a value between 0.5-15 seconds) to the wireless transceiver of the BLE reader, there will be a time delay, for example 5 seconds due to a fixed period of transmission, between sending and receiving the sensor's switching state data. If the sensor output state is changed from ON to OFF just after the last transmission cycle, since the next fixed period has not yet reached, the wireless transceiver of the BLE tag won't transmit the sensor output state OFF at this time, and the output state of the BLE reader will still be ON. The output state will be kept for 5 seconds before it is refreshed. When the next fixed period of 5 seconds has been reached, the wireless transceiver of the BLE tag will transmit OFF, and the output state of the BLE reader will change accordingly. This is the signal delay caused by the fixed transmission period. The signal delay may result in the sensor gateway failing to promptly detect the patient's out-of-bed behavior, consequently delaying issue an alert to nurse from the sensor gateway timely and increases the risk of falls.

In order to solve the signal delay caused by the fixed transmission period, especially relatively long fixed transmission period (such as 10-15 seconds) which is good to reduce the degree of congestion on the wireless communication channel and improve the stability and reliability of wireless communication systems, the following measures of the present invention can be adopted to ensure that when the sensor state changes, the sensor gateway can obtain the output state of the sensor in time and transmit it to the router and the server in time, so that the output state data of the sensor can be refreshed in time. Furthermore, it can ensure that when the sensor detects the patient leaving the bed, it recognizes whether it is a real patient leaving the bed by timer determination, which effectively solves the false alert problem caused by the patient turning over, and ensures a real alert can be sent to the nurse in time.

Patient's act of turning over can be detected by the sensor, and the timer starting signal is wirelessly transmitted to the second wireless transceiver via the first wireless transceiver, when the second wireless transceiver receives said timer starting signal, the sensor gateway updates the received switch status data to OFF and then the timer of the sensor controller starts counting. Since the patient's body does not actually leave the bed after turning over, the patient's body is again detected by the sensor and the timer resetting signal is transmitted wirelessly from the first wireless transceiver to the second wireless transceiver via the communication controller of the wireless sensor. when the second wireless transceiver receives said timer resetting signal, the sensor gateway updates the received switch status data to ON and then the timer of the sensor controller is reset (timer is cleared to zero), and the timer of the sensor controller stops counting (which means the time of patient leaving bed has not reached the initial delay value), so that the sensor controller does not enter the alert state, avoiding false alerts caused by the patient turning over.

Only when the patient really leaves the bed (the time of patient leaving bed reaches the set initial delay value), and the timer reaches the set initial delay value (which means the time of patient leaving bed reaches the set initial delay value), the sensor controller enters the alert state and outputs an alert signal to the alert devices, ensuring that nurses can receive the alert signal in time, and preventing the patient from falling;

Preferably, the sensor controller (12) further comprises an input device (33) through which the initial value of the timer (16) is input into the sensor controller (12). The initial delay value needs to be set according to the behavioral characteristics of the patient, and usually this number is 1-3 seconds to avoid triggering the false alert of the sensor controller due to the patient turning over in the hospital bed.

Preferably, the sensor gateway further comprises a data logger (34) which stores time-contained key parameters and operation state information of the sensor gateway, the wireless sensor, the ward wireless alert device (25), the wired alert device (20), and the wireless patient station receiver (23), such as standby state, monitoring state, alert state, reset state, pause hold state, battery undervoltage state, the dedicated wireless communication channel of the sensor gateway and the paired wireless sensor, operation logs that have occurred on the operator interface, setup information, alerts and prompts. Error information comprises sensor connection failures, equipment failure information, warning information, wireless connection abnormality information, and battery voltage information. The data logger (34) also comprises an output port (40) for outputting the key parameters and the operation state information to other devices, such as a USB flash drive, a computer, and a wireless smart device. The data logger may be provided in the sensor gateway or on external devices that are connected to the sensor gateway, such as wired alert devices, wireless alert devices, routers, network server, cloud servers, network memories, and wireless smart devices that comprise memories. All information recorded by the data logger can be accessed by other devices in both wired and wireless manner.

The network server has a communication program for receiving and sending data with the smart wireless device, capable of sending information received from the sensor gateway to the smart wireless device, and also capable of receiving information from the smart wireless device. The information transmitted comprises the set initial value of the timer, sensor state information, alert information, reset information, sensor gateway working state information, ward wired alert device working state information, operating information of the operator interface, error information, warning information, wireless connection state information, and battery voltage information.

When the BLE reader receives a signal from the nurse BLE tag of the nurse transmitter, the sensor controller enters an alert reset state and resets the alert.

When the BLE reader does not receive the sensor signal within the fixed period, the sensor controller outputs a sensor loss alert signal to the alert devices as well as to router and the server.

The sensor controller comprises the timer and the set initial value. After receiving the timer starting signal, the timer starts counting. When the timer reaches the set initial time, the sensor controller outputs an alert signal to the alert devices. If the timer resetting signal is received during the counting process, the counting is stopped and the timer is reset.

The first wireless transceiver of the wireless sensor communicates wirelessly with the second wireless transceiver using different initial wireless communication channels.

After the second wireless transceiver receives the data sent by the first wireless transceiver, the second wireless transceiver will send the received data back to the first wireless transceiver. If the first wireless transceiver does not receive the data sent back by the second wireless transceiver or the data sent back is inconsistent with the data sent out before, the first wireless transceiver will send the data to the second wireless transceiver again.

Preferably, the magnetic field sensor (5) has a trigger threshold, when the magnetic field detected by the magnetic field sensor (5) reaches the trigger threshold, output of the magnetic field sensor changes. When the magnetic field generator (15) and the magnetic field sensor (5) are close to each other, the magnetic field sensor (5) determines that the magnetic field generated by the magnetic field generator (15) reaches the trigger threshold, then the magnetic field sensor (5) outputs a signal that triggers the communication controller (6) of the wireless sensor, in such a manner that the sensor transmitter and the sensor gateway enter a pairing process to establish a wireless connection which remains after the magnetic field generator (15) and the magnetic field sensor (5) move away from each other.

Reed switches have two main forms: normally open (NO) and normally closed (NC). In a normally open reed switch, when an external magnetic field is applied, the reed closes and the circuit is energized; when the external magnetic field disappears, the reed returns to its original state due to its elasticity and the circuit is broken. On the contrary, in a normally closed reed switch, when an external magnetic field is applied, the reed remains open and the circuit does not conduct; when the external magnetic field disappears, the reed closes and the circuit conducts.

Preferably, the magnetic field sensor (5) is a normally open reed switch, which comprises a normally open output contact; when the reed switch detect an insufficient magnetic field strength, the output contact of the reed switch is in a disconnected state; when the reed switch detects a sufficient magnetic field strength which reaches the trigger threshold, the output contact of the reed switch is closed, triggering the communication controller MCU (7) of the wireless sensor to enter the pairing process.

One to more wireless sensors can be wirelessly connected to the sensor Gateway to form a wireless smart sensing system. The first wireless transceiver and the second wireless transceiver of the sensor gateway adopt a number of wireless communication channels that are usable with different radio frequencies. Each wireless communication channel corresponds to one unique radio frequency and one unique code. There is also a dedicate initial wireless communication channel, which may be any one of several wireless communication channels. The first wireless transceiver first uses the dedicate initial wireless communication channel to communicate wirelessly with the second wireless transceiver. The communication protocol of the gateway communication controller of the sensor gateway comprises an initial wireless communication channel assignment algorithm and a frequency hopping algorithm, wherein the initial wireless communication channel assignment algorithm is used for assigning and setting a plurality of dedicated wireless communication channels for each sensor gateway of a plurality of wireless smart sensing systems (1-5 dedicated wireless communication channels for each sensor gateway), such that the dedicated wireless communication channels for each sensor gateway are different from each other. When a sensor gateway is paired with a wireless transmitter, the initial wireless communication channel assignment algorithm assigns a dedicated wireless communication channel for the first wireless transceiver of each paired sensor transmitter as the dedicated initial wireless communication channel for the first wireless transceiver, and the dedicated initial wireless communication channels for the sensor transmitters paired with the same sensor gateway are different from each other. The second wireless transceiver transmits a code of the assigned dedicate initial wireless communication channel to the first wireless transceiver, and then transmits the code to the communication controller of the sensor transmitter. The code of the dedicate initial wireless communication channel is stored in the memory of the sensor transmitter and the memory of the sensor gateway, respectively. After pairing, the first wireless transceiver of the sensor transmitter communicates with the second wireless transceiver of the sensor gateway using the dedicate initial wireless communication channel. The initial wireless communication channel assignment algorithm assigns different dedicate initial wireless communication channels for the first wireless transceivers of each sensor transmitter in the wireless smart sensing system. The sensor transmitter and the second wireless transceiver of the sensor gateway first use the dedicate initial wireless communication channel to communicate wirelessly, and when radio interference occurs on the dedicate initial wireless communication channel that disables the wireless communication, the sensor transmitter and sensor gateway can temporarily borrow a wireless communication channel other than the dedicate initial wireless communication channel through frequency hopping algorithm for wireless communication. When the radio interference on the dedicate initial wireless communication channel disappears, the sensor transmitter and the sensor gateway restore the dedicate initial wireless communication channel for wireless communication. After pairing, the second wireless transceiver scans all wireless communication channels, and when it receives a communication request on the dedicate initial wireless communication channel of a certain sensor transmitter, the second wireless transceiver uses that wireless communication channel to communicate wirelessly with the first wireless transceiver of the sensor transmitter.

The initial wireless communication channel assignment algorithm also re-adjusts the dedicate initial wireless communication channel that has been assigned. When serious radio interference caused the continuous wireless communication failure, occurs on the dedicate initial wireless communication channel, the initial wireless communication channel assignment algorithm re-assigns a code of a different initial wireless communication channel for the wireless transmitter that is affected, and stops the use of the dedicate initial wireless communication channel that was originally assigned. The second wireless transceiver transmits the reassigned code of the dedicate initial wireless communication channel back to the first wireless transceiver and then to the communication controller of the sensor transmitter, wherein the reassigned code of the dedicate initial wireless communication channel is stored in the memory of the sensor transmitter and the memory of the sensor gateway, respectively.

The sensor gateways of the plurality of wireless smart sensing systems may communicate wirelessly with each other, wherein one sensor gateway may communicate wirelessly with another sensor gateway to transmit the codes of the initial wireless communication channels that have been already utilized. The initial wireless communication channel assignment algorithm can also plan the available initial wireless communication channels for the plurality of sensor gateways in a well-coordinated way, so that each sensor gateway of the wireless smart sensing systems uses a different initial wireless communication channel from each other. If all of the available initial wireless communication channels have been occupied, the occupied initial wireless communication channels may also be reassigned, for example, to the first wireless transceiver of a newly paired sensor transmitter. The reassigned initial wireless communication channels are different from each other, so that the number of paired sensor transmitters on the same initial wireless communication channel is minimized. The advantage is that each wireless sensor operates on a different channel, thus reducing the probability of co-channel interference and improving the reliability of wireless communication.

The pressure sensor can be a pressure sensitive switch sensor that outputs a pressure sensitive switch signal, or an analog sensor that outputs an analog pressure signal. The sensor can adopt single pressure sensing unit corresponding to a single pressure sensor output (both Smart and Posey adopt one pressure sensitive switch sensor); or adopt multiple independent pressure sensors with independent outputs. According to the embodiment, the wireless pressure sensor comprises multiple independent pressure sensing units, each unit is distributed in a different location in the hospital bed, such as from the center area of the bed to edges of the bed, thereby detecting pressures generated by different body parts of the patient, as well as changes in the body position and body posture. This is useful and important for detecting whether a patient turns over in bed or not, and for nurses to prevent bedsores that can be easily developed on the body of the patient due to pressure for a long period of time.

There may be a plurality of independent pressure sensors distributed at different locations of bed, and each pressure sensor may independently detect pressure and output a pressure sensing switch signal to the communication controller of the sensor transmitter. The communication controller of the wireless sensor collects switch state data of each pressure sensor, and the switch state data will be sent to the wireless transceiver of the BLE reader through the wireless transceiver of the BLE tag of the wireless sensor at a fixed period (e.g., once per second).

The BLE reader can be paired to establish wireless communication with the wireless sensor BLE tag, the patient BLE tag, and the nurse BLE tag. The BLE tag works in BLE broadcast mode to broadcast a wireless signal, and the BLE reader receives the wireless signals emitted by the BLE tag of the wireless sensor, the BLE patient tag and the BLE nurse tag. The BLE reader comprises a received signal strength indicator (RSSI), which measures the received wireless signal strength to estimate a distance between the BLE tag and the BLE reader of the sensor gateway, thus positioning the BLE tag. If the estimated distance is less than or equal to a set proximity pairing distance threshold (0-30 centimeters), then the proximity pairing operation is recognized as a valid operation.

Preferably, the sensor gateway further comprises a pause switch (37). When the nurse needs to push the patient and the bed out of the ward to do some examination, the pause switch is then set to ON, wherein the sensor controller of the sensor gateway pauses to monitor the wireless connection state between the sensor gateway and the wireless sensors. Under such condition, if the BLE reader does not receive a sensing state signal from the wireless sensor within the fixed period, the sensor controller will not output a sensor loss alert signal to the alert device as well as to router and the server. When the nurse pushes the patient and the bed back to the ward, the pause switch is then set to OFF, wherein the sensor controller of the sensor gateway monitors the wireless connection state between the sensor gateway and the wireless sensors. Under such condition, if the BLE reader does not receive a sensing state signal from the wireless sensor within the fixed period, the sensor controller will output a sensor loss alert signal to the alert device as well as to router and the server. The pause switch (37) is a mechanical two-position switch or an electronic switch with push-button triggering; and the pause switch (37) is a dedicated switch or a multiplexed switch. For example, the pause switch (37) is multiplexed with a HOLD button that can pause the monitoring function. If the monitoring is deactivated through the pause switch, the sensor controller (together with the alert device) will not output the sensor loss alert signal. If the monitoring is activated through the pause switch, the sensor controller (together with the alert device) can output the sensor loss alert signal.

The sensor controller can be connected to multiple alert devices. Based on the logical judgment of the received sensing state signal, the sensor controller outputs an alert or reset signal to the alert device.

The connection between the sensor controller and the alert devices comprises wired and wireless methods, so as to transmit alert or reset signals by wired or wireless means.

Each sensor gateway may comprise multiple sensor controllers connected to multiple wireless sensors, respectively.

The sensor gateway is also connected to the router to push sensor state data and output data of the sensor controller.

The sensor gateway and the alert device can be located in the same shell, in which they are connected by wired means. The sensor gateway and the alert device can also be located in different shells, in which they are connected wirelessly.

These and other objectives, features, and advantages of the present invention will become apparent from the following detailed description, the accompanying drawings, and the appended claims.

### BRIEF DESCRIPTION OF THE DRAWINGS

FIG. 1 is a structural view of a wireless monitoring system according to a preferred embodiment 1 of the present invention;

FIG. 2 is a sketch view of a wireless sensor according to the preferred embodiment 1 of the present invention;

FIG. 3 is an exploded view of a pressure sensor according to the preferred embodiment 1 of the present invention;

FIG. 4 is a structural view of the wireless monitoring system according to a preferred embodiment 2 of the present invention;

FIG. 5 is a flow chart of an alert process according to the wireless monitoring system of the present invention;

FIG. 6 is a sketch view of a wireless patient station receiver according to a preferred embodiment 3 of the present invention;

FIG. 7 is a flow chart of a pairing process between a wireless sensor and a sensor gateway according to a preferred embodiment 6 of the present invention; and

FIG. 8 is a structural view of a wireless monitoring system according to a preferred embodiment 8 of the present invention.

Element reference: 1—pressure sensor; 2—first wireless transceiver; 3—BLE tag; 4—BLE wireless transceiver; 5—magnetic field sensor; 6—communication controller; 7—communication controller MCU; 8—communication controller memory; 9—second wireless transceiver; 10—BLE reader; 11—gateway communication controller; 12—sensor controller; 13—third wireless transceiver; 14—forth wireless transceiver; 15—magnetic field generator; 16—timer; 17—gateway MCU; 18—gateway memory; 19—wireless alert device; 20—wired alert device; 21—patient BLE tag; 22—nurse BLE tag; 23—wireless patient station receiver; 24—patient station; 25—ward wireless alert device; 26—upper conductive film; 27—lower conductive film; 28—elastic isolation layer; 29—network server; 30—Bluetooth transceiver; 31—wireless smart device; 32—router; 33—input device; 34—data logger; 35—voltage detector; 36—rectifier bridge; 37—pause switch; 38—perforated holes; 39—operator interface; 40—output port; 41—ward wired alert device; 42—alert output relay.

### DETAILED DESCRIPTION OF THE PREFERRED EMBODIMENT

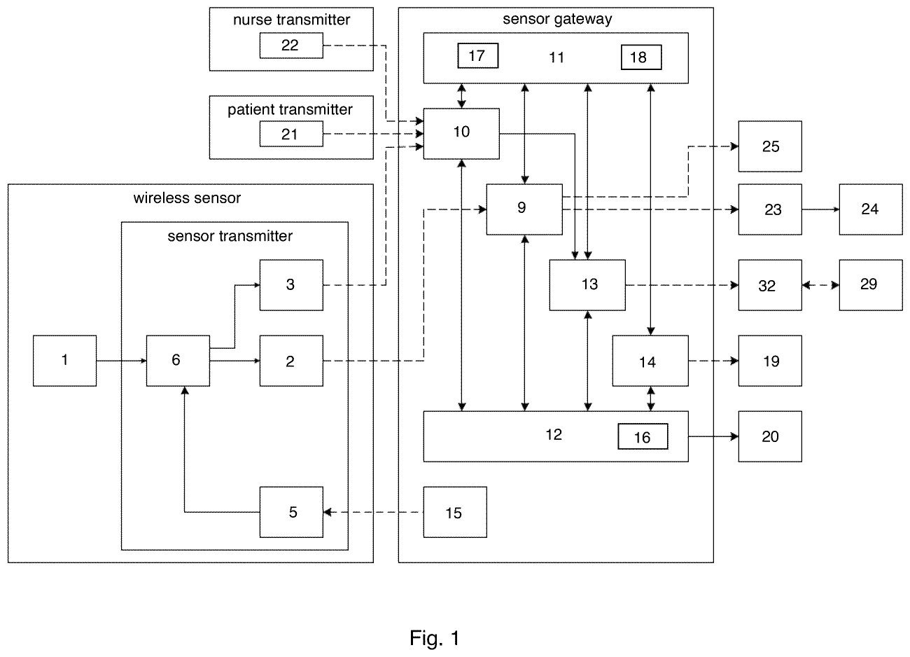

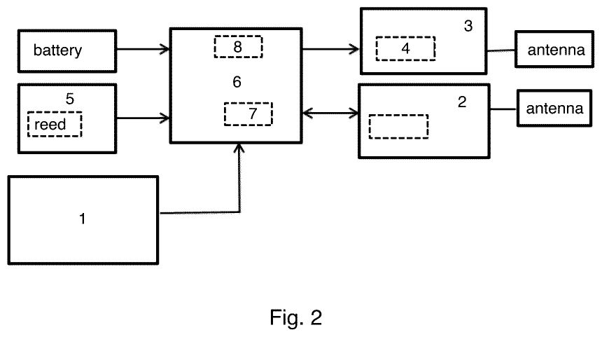

Referring to FIGS. 1-2 of the drawings, a wireless monitoring system according to a preferred embodiment 1 of the present invention is illustrated, comprising:
a wireless sensor, comprising a pressure sensor 1 and a sensor transmitter; wherein the sensor transmitter comprises a first wireless transceiver 2, a BLE tag 3 having a BLE wireless transceiver 4, a magnetic field sensor 5 and a communication controller 6; wherein the pressure sensor 1, the first wireless transceiver 2, the BLE tag 3 and an output of the magnetic field sensor 5 are connected to the communication controller 6; the communication controller comprises a communication controller MCU 7 and a communication controller memory 8 containing an embedded program for a communication protocol; the communication controller 6 controls a bidirectional wireless communication between the first wireless transceiver 2 and a second wireless transceiver 9, as well as controls a wireless communication between the BLE wireless transceiver 4 and a BLE reader 10;
a sensor gateway, comprising a gateway communication controller 11, the BLE reader 10 having a wireless transceiver module, the second wireless transceiver 9, a sensor controller 12, a third wireless transceiver 13, a fourth wireless transceiver 14, and a magnetic field generator 15; wherein the second wireless transceiver 9, the BLE reader 10, the third wireless transceiver 13 and the fourth wireless transceiver 14 are connected to the gateway communication controller 11 and the sensor controller 12, respectively; the sensor controller 12 comprises a timer 16, and provides an operator interface 39 for setting or modifying an initial value of the timer 16; the gateway communication controller 11 comprises a gateway MCU 17 and a gateway memory 18 containing the embedded program for the communication protocol; the gateway communication controller 11 and the sensor controller 12 communicates with each other; the gateway communication controller 11 controls a communication between the first wireless transceiver 2 and the second wireless transceiver 9, controls the wireless communication between the BLE wireless transceiver 4 and the BLE reader 10, controls a wireless communication between the third wireless transceiver 13 and a router 32, and controls a wireless communication between the fourth wireless transceiver 14 and a wireless alert device 19; the magnetic field generator 15 is arranged on the sensor gateway, and the magnetic field sensor 5 of the wireless sensor detects a magnetic field of the magnetic field generator 15;
a patient transmitter, comprising a patient BLE tag 21 communicating with the BLE reader 10, which periodically sends information containing a code representing a risk level of a patient and a unique ID of the patient transmitter to the BLE reader 10; and
a nurse transmitter, comprising a nurse BLE tag 22 communicating with the BLE reader 10, which periodically sends information containing unique ID of the nurse transmitter to the BLE reader 10.

The sensor controller 12 is connected to a wired alert device 20, so as to output an alert signal to the wired alert device 20; the wired alert device 20 and the sensor gateway are arranged in a same shell to form a wireless fall monitor.

The wireless sensor is a wireless sensor pad, which is configured to be placed on a bed, a sofa, a chair, a wheelchair or a toilet.

Preferably, the wireless alert device 19 communicates with the fourth wireless transceiver 14 to receive a wireless alert signal from the sensor controller 12.

Under control of the gateway communication controller, a wireless patient station receiver 23 communicates with the second wireless transceiver 9 to receive a wireless alert signal from the sensor controller 12, and then sends the wireless alert signal to a patient station 24.

A ward wireless alert device 25 communicates with the second wireless transceiver 9 to receive a wireless alert signal from the sensor controller 12.

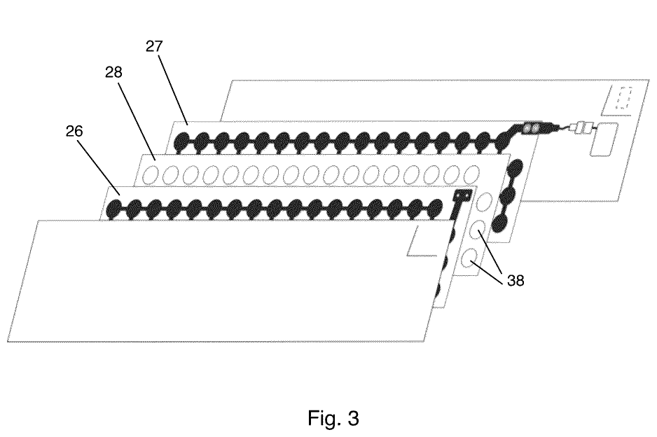

Referring to FIG. 3, the pressure sensor 1 is a pressure sensitive switch sensor; a pressure sensing circuit of the pressure sensor 1 comprises an upper conductive film 26, a lower conductive film 27, and an elastic isolation layer 28; wherein the elastic isolation layer 28 is perforated; the upper conductive film 26 and the lower conductive film 27 are isolated from each other by the elastic isolation layer 28. The upper conductive film 26 and the lower conductive film 27 corresponds to two electrodes of a pressure sensitive switch. The pressure sensor 1 also comprises two output electrode slices that are connected to the upper conductive film 26 and the lower conductive film 27. When the patient's body is pressed on the top of the bed pressure sensor, the upper conductive film is pressurized and deformed, so as to contact the lower conductive film through perforated holes 38 on the elastic isolation layer. At this time, the pressure sensitive switch is turned on, and the two output electrode slices output ON. That is to say, the pressure sensor detects the pressure and outputs a corresponding ON signal. When the patient's body is not on the top of the bed pressure sensor, the upper conductive film is restored to flatness, and is isolated from the lower conductive film by the elastic isolation layer. At this time, the pressure sensitive switch is turned off, and the two output electrode slices output OFF. That is to say, the pressure sensor does not detect the pressure and outputs a corresponding OFF signal. The two output electrode slices of the pressure sensor are connected to two inputs of the communication controller of the wireless sensor, respectively. In addition to the wireless pressure sensor for the hospital bed, the system can also comprise wireless pressure sensors for bedside chairs, toilets, seat belts and other locations, as long as the pressure generated by the patient's body weight can be detected.

The working process of the wireless sensor is as follows:

The output signal of the pressure sensor is input to the MCU 7 of the sensor transmitter communication controller 6, and the MCU controls the wireless transceiver of the BLE tag to transmit an output signal of the pressure sensor (switch status data) at a fixed period between 0.5-15 seconds to the wireless transceiver of the BLE reader. When the patient's body is pressed on the top of the pressure sensor, the output signal is ON, the data sent by the wireless transceiver of the BLE tag is ON, and the data received by the BLE reader is ON. When the patient's body is not pressed on the top of the pressure sensor, the output signal is OFF, the data sent by the wireless transceiver of the BLE tag is OFF, and the data received by the BLE reader is OFF. The gateway communication controller then controls the third wireless transceiver to send the data received by the BLE reader to the router receiver, and the router receiver sends the data to a network server. The network server records and stores the data, and then sends the data to a smart wireless device within the network, so that the smart wireless device can obtain the output signal data from the pressure sensor.

The communication controller 6 of the wireless sensor is connected to the pressure sensor 1, and the MCU 7 of the communication controller 6 collects a switch status data output by the pressure sensor 1, and periodically transmits information containing unique ID of said sensor transmitter and the switch status data to the BLE reader 10 through the BLE wireless transceiver 4 of the BLE tag 3 at a fixed period; and then the BLE reader 10 transmits the switching state data to the third wireless transceiver 13 (e.g., adopting an ESP8266 chip); the third wireless transceiver 13 transmits the switching state data along with an alert signal and a reset signal output by the sensor controller 12 to the router 32; the router 32 transmits the switching state data, the alert signal and the reset signal to a network server 29. The sensor gateway also communicates with a cloud server via a TCP-based protocol stack (e.g., TCP/TLS+MQTT) to transmit the switching state data, the alert signal and the reset signal data to the cloud server. The data transmitted by the sensor gateway to the router also includes information of the sensor gateway, wireless sensors, patient BLE tags, nurse BLE tags, and the required information, such as patient ID and risk level code.

The fixed period is 0.5-15 seconds.

When the BLE reader (10) does not receive the switch status data transmitted from the BLE wireless transceiver (4) of the BLE tag (3) to the BLE reader (10) after one fixed period, the sensor gateway outputs a sensor lost signal and an alert signal.

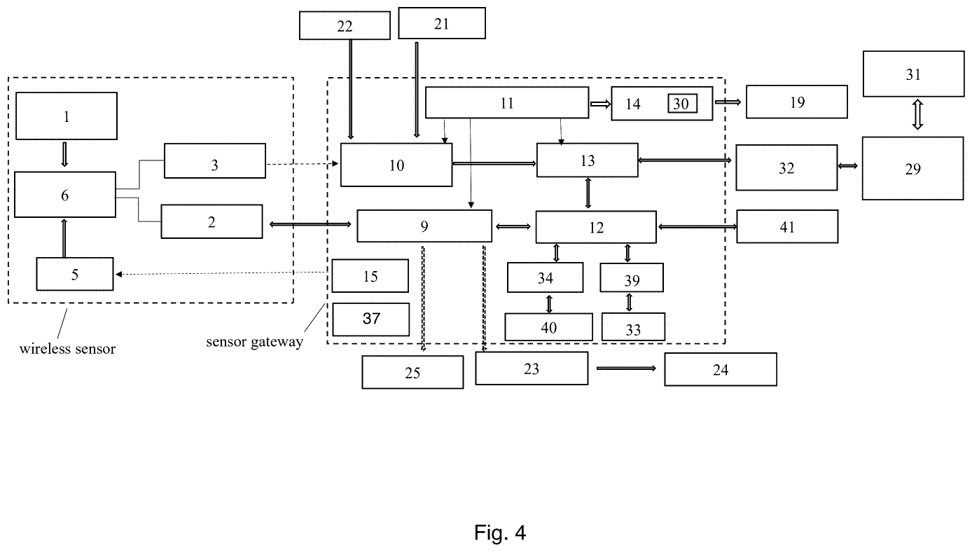

Referring to FIG. 4, according to a preferred embodiment 2 of the present invention, the fourth wireless transceiver comprises a Bluetooth transceiver 30, and the Bluetooth transceiver 30 transmits the switching state data, the alert signal and the reset signal to a wireless smart device 31 or the wireless alert device 19. The wireless smart device can be a cell phone or a tablet.

The wireless smart device connected to the network can access the server via the network, so as to obtain the patient ID and risk level code and the switching state data of the pressure sensor, as well as the alert signal and the reset signal data output by the sensor controller, thus when a monitored person gets up from the wireless sensor, the wireless sensor transmitter will send a signal to the sensor gateway to trigger an alert on the sensor gateway, the alert device and the wireless smart device which can display alert information including the patient's risk level, enabling nurses to make appropriate responses based on the patient's risk level. The sensor gateway comprises at least one MCU and a memory with embedded program by which the functions of the gateway communication controller and the functions of the sensor controller are realized. The embedded program comprises a plurality of communication protocols, including the communication protocol of the BLE reader, the communication protocol of the second wireless transceiver, the communication protocol of the third wireless transceiver, and the communication protocol of the fourth wireless transceiver. The sensor gateway also comprises embedded program for protocol conversion and data push, which can support various communication protocols such as RS485, Modbus and MQTT, thereby converting the switching state data into standard format such as JSON.

The number of wireless sensors in hospitals usually reaches hundreds or even thousands. The data refresh frequency of wireless sensors will directly affect the wireless communication data volume of wireless sensors and the degree of congestion on the wireless communication channel. If the wireless sensor communication is very frequent, the probability of wireless communication collision will be greatly increased, which is likely to make the entire wireless communication system unstable, resulting in serious reliability problem. Moreover, frequent wireless communication also requires a larger capacity of battery power. In order to solve this problem, it is necessary to prolong the wireless communication cycle of each wireless sensor, using a relatively long fixed transmission period to transmit the sensor's switching state data, which in turn will bring in signal delay problem caused by a too long refresh time of the wireless sensor data time.

According to the present invention, due to the BLE wireless transceiver of the BLE tag of the wireless sensor transmits the switching state data in a fixed period between 0.5-15 seconds to the wireless transceiver of the BLE reader, there will be a time delay, for example 5 seconds due to a fixed period of transmission, between sending and receiving the sensor's switching state data. If the sensor output state is changed from ON to OFF just after the last transmission cycle, since the next fixed period has not yet reached, the wireless transceiver of the BLE tag won't transmit the sensor output state OFF at this time, and the output state of the BLE reader will still be ON. The output state will be kept for 5 seconds before it is refreshed. When the next fixed period of 5 seconds has been reached, the wireless transceiver of the BLE tag will transmit OFF, and the output state of the BLE reader will change accordingly. This is the signal delay caused by the fixed transmission period. The signal delay may result in the sensor gateway failing to promptly detect the patient's out-of-bed behavior, consequently delaying issue an alert to nurse from the sensor gateway timely and increases the risk of falls.

To solve the problem of signal delay caused by fixed transmission cycles, especially relatively long fixed transmission cycles (such as 10 seconds)

In order to solve the signal delay caused by the fixed transmission period, especially relatively long fixed transmission period (such as 10-15 seconds) which is good to reduce the degree of congestion on the wireless communication channel and improve the stability and reliability of wireless communication systems, the following measures of the present invention can be adopted to ensure that when the sensor state changes, the sensor gateway can obtain the output state of the sensor in time and transmit it to the router and the server in time, so that the output state data of the sensor can be refreshed in time. Furthermore, it can ensure that when the sensor detects the patient leaving the bed, it recognizes whether it is a real patient leaving the bed by timer determination, which effectively solves the false alert problem caused by the patient turning over, and ensures a real alert can be sent to the nurse in time.

The first wireless transceiver is wirelessly connected to the second wireless transceiver, and when the sensor detects the presence of the patient, controls the first wireless transceiver to wirelessly transmit the reset timer signal to the second wireless transceiver via the communication controller of the wireless sensor. The timer of the sensor controller is then reset, and the sensor controller exits the alert state. At the same time, the BLE tag is in wireless communication with the BLE reader. The wireless transceiver circuit of the BLE tag transmits the state signal of the sensor to the BLE reader at a fixed period, and transmits it through the third wireless transceiver to the router, and then transmits it through the router to the server, thereby pushing the state signal of the sensor to the smart wireless devices in the network.

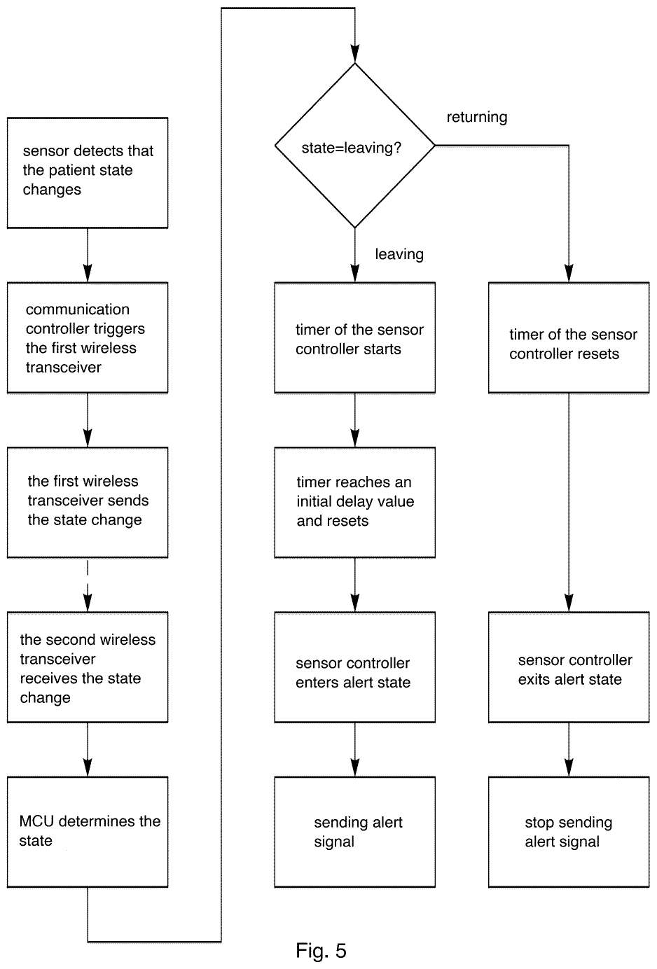

Referring to FIG. 5, when the communication controller of the sensor transmitter detects a change in the sensor output corresponding to patient leaving the sensor, namely the sensor detects that the patient state changes from being in the hospital bed to being out of the hospital bed, and the sensor output signal changes from ON to OFF, a timer starting signal is wirelessly transmitted through the first wireless transceiver to the second wireless transceiver, when the second wireless transceiver receives said timer starting signal, the sensor gateway updates the received switch status data to OFF and the timer of the sensor controller starts from zero. When the timer reaches an initial delay value, the sensor controller enters the alert state and outputs an alert signal to the alert devices. The alert signal and reset signal output from the sensor controller will also be sent through the third wireless transceiver to the router and the network server, which pushes the alert signal to the smart wireless devices in the network. The communication controller of the wireless sensor contains MCU, memory and embedded program to realize the functions of the communication controller of the wireless sensor.

When the communication controller of the sensor transmitter detects a change in the sensor output corresponding to the patient returning to the sensor, namely the sensor detects that the patient state changes from being out of the hospital bed to being in the hospital bed, and the sensor output signal changes from OFF to ON, the communication controller of the wireless sensor transmits a timer resetting signal wirelessly through the first wireless transceiver to the second wireless transceiver, when the second wireless transceiver receives said timer resetting signal, the sensor gateway updates the received switch status data to ON and the timer of the sensor controller is then reset the timer to zero. The timer of the sensor controller stops counting. The sensor controller exits the alert state, and outputs a reset signal to the alert devices to stop alerting. The reset signal output by the sensor controller will also be sent to the router and the network server through the third wireless transceiver, and the reset signal will be further pushed through the server to the smart wireless devices in the network. The timer of the sensor controller adopts forward or reverse counting.

Patient's act of turning over can be detected by the sensor, and the timer starting signal is wirelessly transmitted to the second wireless transceiver via the first wireless transceiver, and then the timer of the sensor controller starts counting. Since the patient's body does not actually leave the bed after turning over, the patient's body is again detected by the sensor and the timer resetting signal is transmitted wirelessly from the first wireless transceiver to the second wireless transceiver via the communication controller of the wireless sensor. At this time, the timer of the sensor controller is reset to zero, and the timer of the sensor controller stops counting, which means the time of patient leaving bed has not reached the initial delay value, so that the controller does not enter the alert state, avoiding false alerts caused by the patient turning over.

Only when the patient really leaves the bed, which means the time of patient leaving bed reaches the set initial delay value, and the timer reaches the set initial delay value, which means the time of patient leaving bed reaches the set initial delay value, the controller enters the alert state and outputs an alert signal to the alert devices, ensuring that nurses can receive the alert signal in time, and preventing the patient from falling.

The sensor controller 12 further comprises an input device 33 through which the initial value of the timer 16 is input into the sensor controller 12. The initial delay value needs to be set according to the behavioral characteristics of the patient, and usually this number is 1-3 seconds to avoid triggering the false alert of the sensor controller due to the patient turning over in the hospital bed.

Information, which is sent by the sensor gateway to the router and the network server via the third wireless transceiver, comprises a dedicated wireless communication channel for the wireless sensor, a connection state, a mounting location, a time of use, a remaining life, and a setup parameter and other required data, such as sensor lost. Working state information of the sensor gateway comprises information on the dedicated wireless communication channel for the sensor gateway, information on paired wireless sensor, as well as information on the wired and wireless alert devices connected to the sensor gateway.

The network server also stores and records working state information received from the sensor gateway and the ward wired alert device 41, operation information on the operator interface, fault information, such as sensor lost, warning information, wireless connection information, and voltage information of a battery.

The sensor gateway further comprises a data logger 34 which stores time-contained key parameters and operation state information of the sensor gateway, the wireless sensor, the ward wireless alert device 25, the wired alert device 20, and the wireless patient station receiver 23, such as standby state, monitoring state, alert state, reset state, pause hold state, battery undervoltage state, the dedicated wireless communication channel of the sensor gateway and the paired wireless sensor, operation logs that have occurred on the operator interface, setup information, alerts and prompts. Error information comprises sensor connection failures, equipment failure information, warning information, wireless connection abnormality information, and battery voltage information. The data logger 34 also comprises an output port 40 for outputting the key parameters and the operation state information to other devices, such as a USB flash drive, a computer, and a wireless smart device. The data logger may be provided in the sensor gateway or on external devices that are connected to the sensor gateway, such as wired alert devices, wireless alert devices, routers, network servers, cloud servers, network memories, and wireless smart devices that comprise memories. All information recorded by the data logger can be accessed by other devices in both wired and wireless manner.

The network server has a communication program for receiving and sending data with the smart wireless device, capable of sending information received from the sensor gateway to the smart wireless device, and also capable of receiving information from the smart wireless device. The information transmitted comprises the set initial value of the timer, sensor state information, alert information, sensor lost information, reset information, sensor gateway working state information, ward wired alert device working state information, operating information of the operator interface, error information, warning information, wireless connection state information, and battery voltage information and other required information.

When the BLE reader receives a signal from the nurse BLE tag of the nurse transmitter, the sensor controller enters an alert reset state and resets the alert.

When the BLE reader does not receive the sensor signal within the fixed period, the sensor controller outputs a sensor loss alert signal to the alert devices as well as to router and the server.

The sensor controller comprises the timer and the set initial value. After receiving the timer starting signal, the timer starts counting. When the timer reaches the set initial time, the sensor controller outputs an alert signal to the alert devices. If a timer resetting signal is received during the counting process, the counting is stopped and the timer is reset.

The first wireless transceiver of the wireless sensor communicates wirelessly with the second wireless transceiver using different initial wireless communication channels.

After the second wireless transceiver receives the data sent by the first wireless transceiver, the second wireless transceiver will send the received data back to the first wireless transceiver. If the first wireless transceiver does not receive the data sent back by the second wireless transceiver or the data sent back is inconsistent with the data sent out before, the first wireless transceiver will send the data to the second wireless transceiver again.

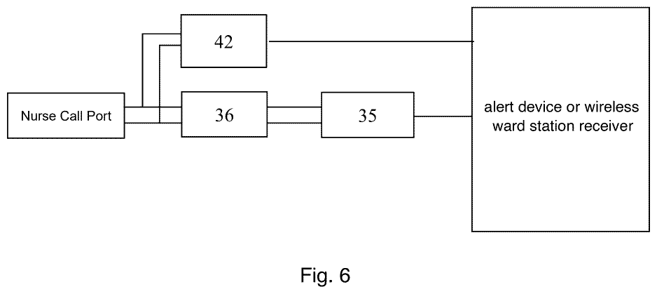

Referring to FIG. 6, according to a preferred embodiment 3 of the present invention, the alert device and the wireless patient station receiver further comprise two output contacts of an alert output relay 42, wherein the two output contacts are connected to two inputs of the patient station by cables. The alert device and the wireless patient station receiver further comprise a connection detection circuit for detecting cables connecting the nurse station, wherein the connection detection circuit comprises a voltage detector 35 and a rectifier bridge 36. The two inputs of the voltage detector 35 are connected to the two output contacts of the alert output relay 42 through the rectifier bridge 36, respectively. That is to say, one input of the voltage detector is connected through the rectifier bridge to one input of the patient station, and the other input of the voltage detector is connected through the rectifier bridge to the other input of the patient station. When the alert device or the wireless patient station receiver is in a non-alert state, the output relay contacts are in a disconnected state, wherein the voltage detector is able to detect the voltage between the two inputs of the patient station through the connected cable and the rectifier bridge. When the cable between the alert device or the wireless patient station receiver and the patient station is disconnected, and when the alert device or the wireless patient station receiver is in a non-alert state, the voltage detector is not able to detect the voltage between the two inputs of the patient station, and the alert device or the wireless patient station receiver outputs a signal indicating an abnormal connection to the patient station, such signal can also be sent to the sensor gateway or other devices connected to the sensor gateway for display “patient station disconnected”.

The magnetic field sensor 5 has a trigger threshold, when the magnetic field detected by the magnetic field sensor 5 reaches the trigger threshold, output of the magnetic field sensor changes. When the magnetic field generator 15 and the magnetic field sensor 5 are close to each other, the magnetic field sensor 5 determines that the magnetic field generated by the magnetic field generator 15 reaches the trigger threshold, then the magnetic field sensor 5 outputs a signal that triggers the communication controller 6 of the wireless sensor, in such a manner that the sensor transmitter and the sensor gateway enter a pairing process to establish a wireless connection which remains after the magnetic field generator 15 and the magnetic field sensor 5 move away from each other.

Reed switches have two main forms: normally open (NO) and normally closed (NC). In a normally open reed switch, when an external magnetic field is applied, the reed closes and the circuit is energized; when the external magnetic field disappears, the reed returns to its original state due to its elasticity and the circuit is broken. On the contrary, in a normally closed reed switch, when an external magnetic field is applied, the reed remains open and the circuit does not conduct; when the external magnetic field disappears, the reed closes and the circuit conducts.

The magnetic field sensor 5 is a normally open reed switch, which comprises a normally open output contact; when the reed switch detect an insufficient magnetic field strength, the output contact of the reed switch is in a disconnected state; when the reed switch detects a sufficient magnetic field strength which reaches the trigger threshold, the output contact of the reed switch is closed, triggering the communication controller MCU 7 of the wireless sensor to enter the pairing process.

According to a preferred embodiment 4 of the present invention, one or more wireless sensors can be wirelessly connected to the sensor gateway to form a wireless smart sensing system. The first wireless transceiver and the second wireless transceiver of the sensor gateway adopt a number of wireless communication channels that are usable with different radio frequencies. Each wireless communication channel corresponds to one radio frequency and one code. There is also an initial wireless communication channel, which may be any one of several wireless communication channels. The first wireless transceiver first uses the initial wireless communication channel to communicate wirelessly with the second wireless transceiver. The communication protocol of the gateway communication controller of the sensor gateway comprises an initial wireless communication channel assignment algorithm and a frequency hopping algorithm, wherein the initial wireless communication channel assignment algorithm is used for assigning and setting 1-5 dedicated wireless communication channels for each sensor gateway of a plurality of wireless smart sensing systems, such that the dedicated wireless communication channels for each sensor gateway are different from each other. When a sensor gateway is paired with a wireless transmitter, the initial wireless communication channel assignment algorithm assigns a dedicated wireless communication channel for the first wireless transceiver of each paired sensor transmitter as the dedicated initial wireless communication channel for the first wireless transceiver, and the dedicated initial wireless communication channels for the sensor transmitters paired with the same sensor gateway are different from each other. The second wireless transceiver transmits a code of the assigned initial wireless communication channel to the first wireless transceiver, and then transmits the code to the communication controller of the sensor transmitter. The code of the initial wireless communication channel is stored in the memory of the sensor transmitter and the memory of the sensor gateway, respectively. After pairing, the first wireless transceiver of the sensor transmitter communicates with the second wireless transceiver of the sensor gateway using the initial wireless communication channel. The initial wireless communication channel assignment algorithm assigns different initial wireless communication channels for the first wireless transceivers of each sensor transmitter in the wireless smart sensing system. The sensor transmitter and the second wireless transceiver of the sensor gateway first use the initial wireless communication channel to communicate wirelessly, and when radio interference occurs on the initial wireless communication channel that disables the wireless communication, the sensor transmitter and sensor gateway can temporarily borrow a wireless communication channel other than the initial wireless communication channel through frequency hopping algorithm for wireless communication. When the radio interference on the initial wireless communication channel disappears, the sensor transmitter and the sensor gateway restore the initial wireless communication channel for wireless communication. After pairing, the second wireless transceiver scans all wireless communication channels, and when it receives a communication request on the initial wireless communication channel of a certain sensor transmitter, the second wireless transceiver uses that wireless communication channel to communicate wirelessly with the first wireless transceiver of the sensor transmitter.

The initial wireless communication channel assignment algorithm also re-adjusts the initial wireless communication channel that has been assigned. When serious radio interference, which affects wireless communication, occurs on the initial wireless communication channel, the initial wireless communication channel assignment algorithm re-assigns a code of a different initial wireless communication channel for the wireless transmitter that is affected, and stops the use of the initial wireless communication channel that was originally assigned. The second wireless transceiver transmits the reassigned code of the initial wireless communication channel back to the first wireless transceiver and then to the communication controller of the sensor transmitter, wherein the reassigned code of the initial wireless communication channel is stored in the memory of the sensor transmitter and the memory of the sensor gateway, respectively.

The sensor gateways of the plurality of wireless smart sensing systems may communicate wirelessly with each other, wherein one sensor gateway may communicate wirelessly with another sensor gateway to transmit the codes of the initial wireless communication channels that have been already utilized. The initial wireless communication channel assignment algorithm can also plan the available initial wireless communication channels for the plurality of sensor gateways in a well-coordinated way, so that each sensor gateway of the wireless smart sensing systems uses a different initial wireless communication channel from each other. If all of the available initial wireless communication channels have been occupied, the occupied initial wireless communication channels may also be reassigned, for example, to the first wireless transceiver of a newly paired sensor transmitter. The reassigned initial wireless communication channels are different from each other, so that the number of paired sensor transmitters on the same initial wireless communication channel is minimized. The advantage is that each wireless sensor operates on a different channel, thus reducing the probability of co-channel interference and improving the reliability of wireless communication.

According to a preferred embodiment 5 of the present invention, the sensor transmitter comprises a 2.4 GHz frequency hopping wireless transceiver circuit, providing 66 wireless communication channels with different radio frequencies. It also comprises a microprocessor and a memory with embedded program, so as to realize the functions of the communication controller of the sensor transmitter. Controlled by the embedded program, the 2.4 GHz frequency hopping wireless transceiver circuit can work in BLE broadcast mode and bi-directional frequency hopping wireless transceiver mode in a time-sharing manner, so as to realize the functions of the BLE tag and the first wireless transceiver.

The sensor gateway comprises a 2.4 GHz frequency hopping wireless transceiver circuit, providing 66 wireless communication channels with different radio frequencies. The wireless transceiver circuit comprises a received signal strength indicator (RSSI), as well as a microprocessor and a memory with embedded program, so as to realize the functions of the gateway communication controller. Controlled by the embedded program, the 2.4 GHz frequency hopping wireless transceiver circuit can work in the BLE receiving mode and the bidirectional frequency hopping wireless transceiver mode in a time-sharing manner, so as to realize the functions of the BLE reader and the second wireless transceiver. Codes of the 66 wireless communication channels are No. 1, No. 2, No. 3, . . . , and No. 66. The initial wireless communication channel assignment algorithm assigns multiple dedicated wireless communication channels for each sensor gateway of the smart sensing system. For example, the dedicated wireless communication channels for sensor gateway No. 1 are wireless communication channels No. 1, No. 2, and No. 3, which may be assigned for the wireless transmitters of three wireless sensors paired to the sensor gateway. For example, the wireless transmitters of the first wireless sensor paired to the sensor gateway No. 1. uses the wireless communication channel No. 1, the wireless transmitter of the second wireless sensor paired to the sensor gateway No. 1 uses the wireless communication channel No. 2, and the wireless transmitter of the third wireless sensor paired to the sensor gateway No. 1 uses the wireless communication channel No. 3. Similarly, the dedicated wireless communication channels for sensor gateway No. 2 are wireless communication channels No. 4, No. 5, and No. 6, which may be assigned for the wireless transmitters of three wireless sensors paired to the sensor gateway. For example, the wireless transmitters of the first wireless sensor paired to the sensor gateway No. 2. uses the wireless communication channel No. 4, the wireless transmitter of the second wireless sensor paired to the sensor gateway No. 2 uses the wireless communication channel No. 5, and the wireless transmitter of the third wireless sensor paired to the sensor gateway No. 2 uses the wireless communication channel No. 6. Also, the dedicated wireless communication channels for sensor gateway No. 3 are wireless communication channels No. 7, No. 8, and No. 9, which may be assigned for the wireless transmitters of three wireless sensors paired to the sensor gateway. The embedded program comprises an initial wireless communication channel assignment algorithm and a frequency hopping algorithm. The initial wireless communication channel assignment algorithm assigns one of the dedicated wireless communication channels to each paired sensor transmitter of the sensor gateway as the initial wireless communication channel of the sensor transmitter. The initial wireless communication channel is stored in the memory of the sensor transmitter and the memory of the sensor gateway, which is used as the dedicated initial wireless communication channel between the two. If there are more than 66 sensor transmitters paired to the sensor gateway, which means that all 66 wireless channels have been assigned, then the newly paired sensor transmitter is assigned in sequence with one of the 66 wireless communication channels already in use.

The sensor transmitter can also use an independent Bluetooth transceiver circuit to realize the functions of the BLE tag, use another independent Bluetooth transceiver circuit to realize the functions of the first wireless transceiver, and use independent microprocessor and memory to realize the functions of the communication controller of the sensor transmitter. Similarly, the sensor gateway can also use an independent Bluetooth transceiver circuit to realize the functions of BLE reader, use another Bluetooth transceiver circuit to realize the functions of second wireless transceiver, and use independent microprocessor and memory to realize the functions of the gateway communication controller.

The pressure sensor can be a pressure sensitive switch sensor that outputs a pressure sensitive switch signal, or an analog sensor that outputs an analog pressure signal. The sensor can adopt a single pressure sensing unit corresponding to a single pressure sensor output; or adopt multiple independent pressure units with independent outputs. According to the embodiment, the wireless pressure sensor comprises multiple independent pressure sensing units, each unit is distributed in a different location in the hospital bed, such as from the center area of the bed to edges of the bed, thereby detecting pressures generated by different body parts of the patient, as well as changes in the body position and body posture. This is useful and important for detecting whether a patient turns over in bed or not, and for nurses to prevent bedsores that can be easily developed on the body of the patient due to pressure for a long period of time.

There may be a plurality of independent pressure sensors distributed at different locations of bed, and each pressure sensor may independently detect pressure and output a pressure sensing switch signal to the communication controller of the sensor transmitter. The communication controller of the wireless sensor collects switch state data of each pressure sensor, and the switch state data will be sent to the wireless transceiver of the BLE reader through the wireless transceiver of the BLE tag of the wireless sensor at a fixed period, e.g., once per second.

The pressure sensor also outputs an analog output electrical signal proportional to the detected pressure. The communication controller of the sensor transmitter acquires the analog pressure electrical signal from each of the pressure sensors by means of an analog-to-digital converter and converts it into the corresponding pressure data. The pressure data are transmitted at a fixed period of 1-10 seconds through the wireless transceiver of the BLE tag of the wireless sensors to the wireless transceiver of the BLE reader.

The BLE reader can be paired to establish wireless communication with the wireless sensor BLE tag, the patent BLE tag, and the nurse BLE tag. The BLE tag works in BLE broadcast mode to broadcast a wireless signal, and the BLE reader receives the wireless signals emitted by the BLE tag of the wireless sensor, the BLE patient tag and the BLE nurse tag. The BLE reader comprises a received signal strength indicator (RSSI), which measures the received wireless signal strength to estimate a distance between the BLE tag and the BLE reader of the sensor gateway, thus positioning the BLE tag.

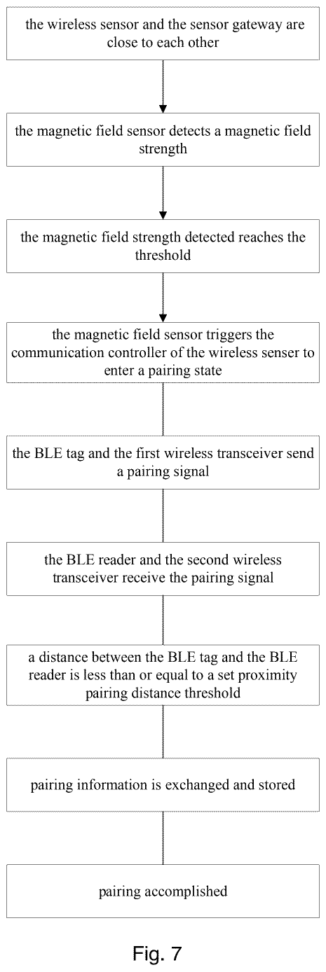

Referring to FIG. 7, according to a preferred embodiment 6 of the present invention, a proximity pairing process of the wireless sensor and the sensor gateway is as follows. The communication controller of the wireless sensor comprises an MCU and a magnetic field sensor formed by a reed switch, wherein an output of the magnetic field sensor is connected to an input of the MCU. Before pairing, the communication controller MCU, the first wireless transceiver, and the BLE tag of the wireless sensor are in a standby mode, while the sensor gateway is in working mode, and the BLE reader can receive wireless pairing signals. The actual working current of a battery of the wireless sensor is about 2 microamps, which saves the battery energy consumption of the wireless sensor from the factory until it begins to be used (a period that may be as long as a dozen months). When the magnetic field sensor (the reed switch) detects a magnetic field signal with sufficient magnetic field strength (When nurse brought an unpaired wireless sensor close to the magnetic field generator of the wireless gateway, it caused the magnetic field sensor to approach the magnetic field generator.), the contact of the reed switch is activated, causing a level change at the input port of the MCU with which the contact is connected. Then the MCU wakes up so that the communication controller of the wireless sensor enters a pairing state. During the pairing process, the BLE tag of the wireless sensor transmits a pairing signal containing the unique ID of the wireless sensor, and the first wireless transceiver can also transmit a pairing signal containing the unique ID of the wireless sensor at the same time. The BLE reader comprises a received signal strength indicator (RSSI), wherein after the BLE reader receives the wireless pairing signal, it can estimate the distance between the BLE tag and the BLE reader of the sensor gateway by measuring the received wireless pairing signal with the RSSI. If the estimated distance is less than or equal to a set proximity pairing distance threshold (0-30 centimeters), then the proximity pairing operation is recognized as a valid operation, and the unique ID of the wireless sensor contained in the pairing signal emitted by the BLE tag is stored in the gateway memory. At the same time, the initial wireless communication channel assignment algorithm assigns one of the dedicated wireless communication channels of the sensor gateway to the first wireless transceiver of the paired sensor transmitter as a dedicated initial wireless communication channel for the first wireless transceiver. The second wireless transceiver transmits the code of the assigned initial wireless communication channel and gateway ID to the first wireless transceiver, and then transmits to the communication controller the sensor transmitter. The code of the initial wireless communication channel and the gateway ID are stored in the memory of the sensor transmitter, and the code of the initial wireless communication channel of the sensor transmitter is also stored to the memory of the sensor gateway, thereby completing the pairing process between the wireless sensor and the sensor gateway. After the pairing process, a wireless connection is established and remained between the wireless sensor and the sensor gateway. If the estimated distance is greater than the set proximity pairing distance threshold, it is judged as an invalid proximity pairing operation, which avoids false pairing that occurs when the sensor gateway receives pairing signals emitted by distant BLE tags (e.g., BLE tags in neighboring rooms that happen to be in pairing operation). The advantage of using the reed switch as the magnetic field sensor is that the reed switch does not consume power. The magnetic field sensor may also adopt low-power magnetic field sensors, such as Hall devices, which are capable of outputting a level change to wake up the MCU to bring the communication controller of the wireless sensor into the pairing state when enough magnetic field strength is detected.

The method for estimating the distance between the BLE tag and the BLE reader of the sensor gateway also comprises adopting AoA (angle of arrival) and AoD (angle of departure) techniques, utilizing an antenna array at a receiving end to capture a phase difference of the BLE signals, and estimating the distance between the BLE tag and the BLE reader according to the phase difference of the arriving BLE signals caused by the path difference of the multiple antennas. ToF (Time of Flight) can also be used to estimate the distance between the BLE tag and the BLE reader of the sensor gateway by measuring the round-trip time of the BLE signal between the transmitter and the receiver, which estimates the distance between the BLE tag and the BLE reader based on the speed of light or electromagnetic wave.

The proximity pairing process of the patient/nurse BLE tag and the sensor gateway is as follows. A communication controller of the patient/nurse BLE tag comprises an MCU and a magnetic field sensor (e.g., a reed switch), wherein an output of the magnetic field sensor is connected to an input of the MCU. Before pairing, the MCU is in a standby mode. When the magnetic field sensor (the reed switch) detects a magnetic field signal with sufficient magnetic field strength, the contact of the reed switch is activated, causing a level change at the input port of the MCU with which the contact. Then the MCU wakes up and enters a pairing state. During the pairing process, the BLE tag transmits a pairing signal containing an unique ID of the BLE tag, and the BLE reader can receive the wireless pairing signal from the patient/nurse BLE tag. The BLE reader comprises a received signal strength indicator (RSSI), wherein after the BLE reader receives the wireless pairing signal, it can estimate the distance between the BLE tag and the BLE reader of the sensor gateway by measuring the received wireless pairing signal with the RSSI. If the estimated distance is less than or equal to a set proximity pairing distance threshold (0-30 centimeters), then the proximity pairing operation is recognized as a valid operation, and the unique ID of the BLE tag contained in the pairing signal emitted by the BLE tag is stored in the sensor gateway memory, thereby completing the pairing between the BLE tag and the sensor gateway.

Prevention of undesired pairing is as follows. The pairing process of the sensor gateway and the wireless transmitter close to each other can simplify the pairing operation of the nurses, but the sensor gateway that enters into the pairing process may receive wireless pairing signals from more than one BLE tag, and there is a possibility of undesired pairing. By estimating the distance between the BLE tags and the BLE reader of the sensor gateway, the sensor gateway will only pair to the closest BLE tag, which prevents the sensor gateway from mistakenly pairing to BLE tags that are in other rooms.

A method for detecting nurses entering/leaving ward is as follows. When the sensor gateway installed in the ward receives the signal from the BLE tag of the nurse transmitter, it can discriminate that the nurse is entering/leaving the ward by estimating the distance between the BLE tag and the BLE reader of the sensor gateway. When the nurse enters the ward, the sensor gateway can output a reset signal to reset the alert. The sensor gateway can also send the information about the nurse entering the ward (including the unique ID of the nurse and the time of entering/leaving) to the network server, wherein the information can be pushed to the wireless smart devices connected to the network to record and display the nurse's behavior, which can be used as a basis for nurse evaluation, performance appraisal, and nursing care improvement based on the analysis of the data.

A method for detecting patients entering/leaving ward is as follows. When the sensor gateway installed in the ward receives the signal from the BLE tag of the patient transmitter, it can discriminate that the patient is entering/leaving the ward by estimating the distance between the BLE tag and the BLE reader of the sensor gateway. The sensor gateway can also send the information about the patient entering the ward (including the unique ID of the patient and the time of entering/leaving) to the network server, wherein the information can be pushed to the wireless smart devices connected to the network to record and display the patient's behavior, which can be used for nursing care improvement based on the analysis of the data.

Wireless connection monitoring between the sensor gateway installed in the ward and wireless sensor is as follows. When the patient is detected to have left the ward, the sensor controller of the sensor gateway pauses to monitor the wireless connection state between the sensor gateway and the wireless sensor. Under such condition, if the BLE reader does not receive a sensing state signal from the wireless sensor within the fixed period, the sensor controller will not output a sensor loss alert signal to the alert device. When the patient is detected to have entered the ward, the sensor controller of the sensor gateway monitors the wireless connection state between the sensor gateway and the wireless sensor. Under such condition, if the BLE reader does not receive a sensing state signal from the wireless sensor within the fixed period, the sensor controller will output a sensor loss alert signal to the alert device.

According to a preferred embodiment 7 of the present invention, the sensor gateway further comprises a pause switch 37. When the nurse needs to push the patient and the bed out of the ward to do some examination, the pause switch is then set to ON, wherein the sensor controller of the sensor gateway pauses to monitor the wireless connection state between the sensor gateway and the wireless sensors. Under such condition, if the BLE reader does not receive a sensing state signal from the wireless sensor within the fixed period, the sensor controller will not output a sensor loss alert signal to the alert device. When the nurse pushes the patient and the bed back to the ward, the pause switch is then set to OFF, wherein the sensor controller of the sensor gateway monitors the wireless connection state between the sensor gateway and the wireless sensors. Under such condition, if the BLE reader does not receive a sensing state signal from the wireless sensor within the fixed period, the sensor controller will output a sensor loss alert signal to the alert device. The pause switch 37 is a mechanical two-position switch or an electronic switch with push-button triggering; and the pause switch 37 is a dedicated switch or a multiplexed switch. For example, the pause switch 37 is multiplexed with a HOLD button that can pause the monitoring function. If the monitoring is deactivated through the pause switch, the sensor controller (together with a wireless monitor) will not output the sensor loss alert signal. If the monitoring is activated through the pause switch, the sensor controller (together with a wireless monitor) can output the sensor loss alert signal.

A method for detecting patient approaching a hospital access door is as follows. According to yet another embodiment of the present invention, the sensor gateway is installed in a hospital access control system, which can identify the patient BLE tag of an approaching patient, so as to prevent the hospitalized patients from leaving the hospital without authorization. Specifically, when the sensor gateway installed at the hospital access door receives the signal from the patient BLE tag, the distance between the BLE tag and the BLE reader of sensor gateway can be estimated to determine the distance between the patient and the hospital access door. When the patient is too close to the access door and has a tendency to leave, the sensor gateway can send out an alert to the healthcare personnel to bring the patient back to the ward.

Functions of hospital positioning system are as follows. A hospital positioning system according to the embodiment comprises a plurality of positioning receivers installed in passages or wards in the hospital. Each of the positioning receivers comprises a sensor gateway that can detect BLE tags of close-by patient transmitters. When the sensor gateway of the positioning receiver installed at a certain location receives a BLE tag signal from a patient transmitter, the patient's position is calculated by estimating the distance between the patient BLE tag and the BLE reader of the sensor gateway. The sensor gateway then sends the ID and position of the patient to the network server, thereby pushing them to smart wireless devices of a hospital management system, so that the medical staff can get the location information of the patient. The system can also obtain locations of nurses and medical equipment carrying BLE tags, providing effective and timely management of personnel and equipment.

The sensor controller can be connected to multiple alert devices. Based on the logical judgment of the received sensing state signal, the sensor controller outputs an alert or reset signal to the alert device.

The connection between the sensor controller and the alert devices comprises wired and wireless methods, so as to transmit alert or reset signals by wired or wireless means.

Each sensor gateway may comprise multiple sensor controllers connected to multiple wireless sensors, respectively.

The sensor gateway is also connected to the router to push sensor state data and output data of the sensor controller.

The sensor gateway and the alert device can be located in the same shell, in which they are connected by wired means. The sensor gateway and the alert device can also be located in different shells, in which they are connected wirelessly.

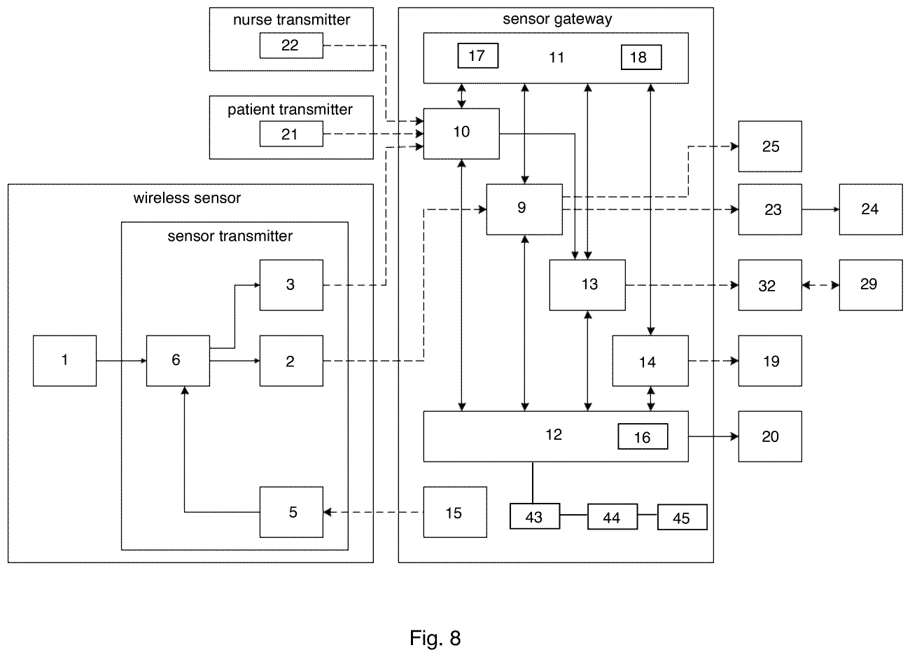

Referring to FIG. 8, according to a preferred embodiment 8 of the present invention, the sensor gateway further comprises a display interface 43 (The controller for visual indicator) and a visual indicator 44; wherein the sensor gateway can work on battery and/or power supply, and may have LED indicators for “sensor lost” and “patient station disconnected” conditions with an audible sound and/or a visual output, such as an LCD or E paper display or other indicator to show in detail the functions required including sensor locations as well as operating status of sensors and the sensor gateway; the sensor gateway further comprises an operating interface 45 such as a switch button to accomplish a desired operation, such as resetting the alert; wherein the gateway communication controller 11, the sensor controller 12, the display interface 43, the visual indicator 44, and the operating interface 45 are connected in sequence.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and are subject to change without departure from such principles. Therefore, this invention comprises all modifications encompassed within the spirit and scope of the following claims.

What is claimed is:

1. A wireless monitoring system, comprising:
a wireless sensor, comprising a pressure sensor (1) and a sensor transmitter; wherein the sensor transmitter comprises a first wireless transceiver (2), a BLE (Bluetooth Low Energy) tag (3) having a BLE wireless transceiver (4), a magnetic field sensor (5) and a communication controller (6); wherein the pressure sensor (1), the first wireless transceiver (2), the BLE tag (3) and an output of the magnetic field sensor (5) are connected to the communication controller (6); the communication controller comprises a communication controller MCU (Microcontroller Unit) (7) and a communication controller memory (8) containing an embedded program for a communication protocol; the communication controller (6) controls a bidirectional wireless communication between the first wireless transceiver (2) and a second wireless transceiver (9), as well as controls a wireless communication between the BLE wireless transceiver (4) and a BLE reader (10);
a sensor gateway, comprising a gateway communication controller (11), the BLE reader (10) having a wireless transceiver module, the second wireless transceiver (9), a sensor controller (12), a third wireless transceiver (13), a fourth wireless transceiver (14), and a magnetic field generator (15); wherein the second wireless transceiver (9), the BLE reader (10), the third wireless transceiver (13) and the fourth wireless transceiver (14) are connected to the gateway communication controller (11) and the sensor controller (12), respectively; the sensor controller (12) comprises a timer (16), and provides an operator interface (39) for setting or modifying an initial value of the timer (16); the gateway communication controller (11) comprises a gateway MCU (17) and a gateway memory (18) containing the embedded program for the communication protocol; the gateway communication controller (11) and the sensor controller (12) communicates with each other; the gateway communication controller (11) controls a communication between the first wireless transceiver (2) and the second wireless transceiver (9), controls the wireless communication between the BLE wireless transceiver (4) and the BLE reader (10), controls a wireless communication between the third wireless transceiver (13) and a router (32), and controls a wireless communication between the fourth wireless transceiver (14) and a wireless alert device (19); the magnetic field generator (15) is arranged on the sensor gateway, and the magnetic field sensor (5) of the wireless sensor detects a magnetic field of the magnetic field generator (15);
a patient transmitter, comprising a patient BLE tag (21) communicating with the BLE reader (10), which periodically sends information containing a code representing a risk level of a patient and a unique ID of the patient transmitter to the BLE reader (10); and
a nurse transmitter, comprising a nurse BLE tag (22) communicating with the BLE reader (10), which periodically sends information containing unique ID of the nurse transmitter to the BLE reader (10).

2. The wireless monitoring system, as recited in claim 1, wherein the sensor controller (12) is connected to a wired alert device (20), so as to output an alert signal or a reset signal to the wired alert device (20).

3. The wireless monitoring system, as recited in claim 2, wherein the wired alert device (20) and the sensor gateway are arranged in a same shell to form a wireless fall monitor.

4. The wireless monitoring system, as recited in claim 1, wherein the wireless sensor is a wireless sensor pad, which is configured to be placed on a bed, a sofa, a chair, a wheelchair or a toilet.

5. The wireless monitoring system, as recited in claim 1, wherein the wireless alert device (19) communicates with the fourth wireless transceiver (14) to receive a wireless alert signal or a reset signal from the sensor controller (12).

6. The wireless monitoring system, as recited in claim 1, wherein under control of the gateway communication controller, a wireless patient station receiver (23) communicates with the second wireless transceiver (9) to receive a wireless alert signal or a reset signal from the sensor controller (12), and then sends the wireless alert signal to a patient station (24).

7. The wireless monitoring system, as recited in claim 1, wherein a ward wireless alert device (25) communicates with the second wireless transceiver (9) to receive a wireless alert signal from the sensor controller (12).

8. The wireless monitoring system, as recited in claim 1, wherein the pressure sensor (1) is a pressure sensitive switch sensor; a pressure sensing circuit of the pressure sensor (1) comprises an upper conductive film (26), a lower conductive film (27), and an elastic isolation layer (28); wherein the upper conductive film (26) and the lower conductive film (27) are isolated from each other by the elastic isolation layer (28) when the upper conductive film (26) is not deformed; and the upper conductive film (26) contacts the lower conductive film (27) when the upper conductive film (26) is deformed.

9. The wireless monitoring system, as recited in claim 8, wherein the elastic isolation layer (28) is perforated; and the upper conductive film (26) contacts the lower conductive film (27) through perforated holes (38) on the elastic isolation layer (28) when the upper conductive film (26) is deformed.

10. The wireless monitoring system, as recited in claim 1, wherein the communication controller (6) of the wireless sensor is connected to the pressure sensor (1), and the MCU (7) of the communication controller (6) collects switch status data output by the pressure sensor (1), and periodically transmits information containing unique ID of said sensor transmitter and the switch status data to the BLE reader (10) through the BLE wireless transceiver (4) of the BLE tag (3) at a fixed period; and then the BLE reader (10) transmits the switching state data to the third wireless transceiver (13); the third wireless transceiver (13) transmits the switching state data along with an alert signal and a reset signal output by the sensor controller (12) to the router (32); and the router (32) transmits the switching state data, the alert signal and the reset signal to a server (29).

11. The wireless monitoring system, as recited in claim 10, wherein the network server (29) has a communication program for receiving and sending data with a smart wireless device, capable of sending information received from the sensor gateway to the smart wireless device, and also capable of receiving information from the smart wireless device; the information transmitted comprises the set initial value of the timer, sensor state information, alert information, reset information, sensor gateway working state information, ward wired alert device working state information, operating information of the operator interface, error information, warning information, wireless connection state information, and battery voltage information

12. The wireless monitoring system, as recited in claim 10, wherein the fixed period is 0.5-15 seconds.

13. The wireless monitoring system, as recited in claim 12, wherein when the BLE reader (10) does not receive the switch status data transmitted from the BLE wireless transceiver (4) of the BLE tag (3) to the BLE reader (10) after one fixed period, the sensor gateway outputs a sensor lost signal and an alert signal.

14. The wireless monitoring system, as recited in claim 10, wherein the fourth wireless transceiver comprises a Bluetooth transceiver (30), and the Bluetooth transceiver (30) transmits the switching state data, the alert signal and the reset signal to a wireless smart device (31) or the wireless alert device (19).

15. The wireless monitoring system, as recited in claim 1, wherein the sensor controller (12) further comprises an input device (33) through which the initial value of the timer (16) is input into the sensor controller (12).

16. The wireless monitoring system, as recited in claim 1, wherein the initial value is 1-3 seconds.

17. The wireless monitoring system, as recited in claim 1, wherein the sensor gateway further comprises a data logger (34) which stores time-contained key parameters and operation state information of the sensor gateway, the wireless sensor, the ward wireless alert device (25), the wired alert device (20), and the wireless patient station receiver (23); the data logger (34) comprises an output port (40) for outputting the key parameters and the operation state information.

18. The wireless monitoring system, as recited in claim 1, wherein the magnetic field sensor (5) has a trigger threshold, when the magnetic field detected by the magnetic field sensor (5) reaches the trigger threshold, the magnetic field sensor (5) outputs a signal that triggers the communication controller (6) of the wireless sensor, in such a manner that the sensor transmitter and the sensor transmitter and the sensor gateway enter a pairing process to establish a wireless connection which remains after the magnetic field generator (15) and the magnetic field sensor (5) move away from each other.

19. The wireless monitoring system, as recited in claim 18, wherein the magnetic field sensor (5) is a normally open reed switch, which comprises a normally open output contact; when the reed switch detect an insufficient magnetic field strength, the output contact of the reed switch is in a disconnected state; when the reed switch detects a sufficient magnetic field strength which reaches the trigger threshold, the output contact of the reed switch is closed, triggering the communication controller MCU (7) of the wireless sensor to enter the pairing process.

20. The wireless monitoring system, as recited in claim 1, wherein the sensor gateway further comprises a pause switch (37) to disable a monitoring function of the sensor gateway.

21. The wireless monitoring system, as recited in claim 20, wherein the pause switch (37) is a mechanical two-position switch or an electronic switch with push-button triggering; and the pause switch (37) is a dedicated switch or a multiplexed switch.

22. The wireless monitoring system, as recited in claim 1, wherein the alert device and the wireless patient station receiver further comprise two output contacts of an alert output relay 42, wherein the two output contacts are connected to two inputs of the patient station by cables; the alert device and the wireless patient station receiver further comprise a connection detection circuit for detecting cables connecting the nurse station, wherein the connection detection circuit comprises a voltage detector 35 and a rectifier bridge 36; the two inputs of the voltage detector 35 are connected to the two output contacts of the alert output relay 42 through the rectifier bridge 36, respectively.

23. The wireless monitoring system, as recited in claim 1, wherein the sensor gateway further comprises a display interface and a visual indicator; wherein the visual indicator is an LED, LCD or E paper display, for displaying desired information of sensors and the sensor gateway; the sensor gateway further comprises an operating interface such as a switch button to accomplish a desired operation.

24. The wireless monitoring system, as recited in claim 1, wherein when the BLE reader receives a signal from the nurse BLE tag of the nurse transmitter, the sensor controller enters an alert reset state and resets the alert.

25. The wireless monitoring system, as recited in claim 1, wherein the first wireless transceiver first uses a dedicated initial wireless communication channel to communicate wirelessly with the second wireless transceiver; the communication protocol of the gateway communication controller of the sensor gateway comprises an initial wireless communication channel assignment algorithm and a frequency hopping algorithm, wherein the initial wireless communication channel assignment algorithm is used for assigning and setting a plurality of dedicated wireless communication channels for each sensor gateway of a plurality of wireless smart sensing systems, such that the dedicated wireless communication channels for each sensor gateway are different from each other; when a sensor gateway is paired with a wireless transmitter, the initial wireless communication channel assignment algorithm assigns a dedicated wireless communication channel for the first wireless transceiver of each paired sensor transmitter as a dedicated initial wireless communication channel for the first wireless transceiver, and the dedicated initial wireless communication channels for the sensor transmitters paired with the same sensor gateway are different from each other.

26. The wireless monitoring system, as recited in claim 25, wherein when radio interference occurs on the initial wireless communication channel that disables the wireless communication, the sensor transmitter and sensor gateway temporarily borrow a wireless communication channel other than the initial wireless communication channel through the frequency hopping algorithm for wireless communication; when the radio interference on the initial wireless communication channel disappears, the sensor transmitter and the sensor gateway restore the initial wireless communication channel for wireless communication.

27. The wireless monitoring system, as recited in claim 26, wherein after pairing, the second wireless transceiver scans all wireless communication channels, and when it receives a communication request on the initial wireless communication channel of a certain sensor transmitter, the second wireless transceiver uses that wireless communication channel to communicate wirelessly with the first wireless transceiver of the sensor transmitter.

28. The wireless monitoring system, as recited in claim 27, wherein the initial wireless communication channel assignment algorithm also re-adjusts the initial wireless communication channel that has been assigned; when serious radio interference occurs on the initial wireless communication channel, the initial wireless communication channel assignment algorithm re-assigns a different initial wireless communication channel for the wireless transmitter that is affected, and stops the use of the initial wireless communication channel that is originally assigned;

29. The wireless monitoring system, as recited in claim 28, wherein the sensor gateways of a plurality of wireless smart sensing systems communicate with each other, wherein one sensor gateway communicates with another sensor gateway to transmit the information of the initial wireless communication channels that have been already utilized; the initial wireless communication channel assignment algorithm also plans the available initial wireless communication channels for the plurality of sensor gateways in a well-coordinated way, so that each sensor gateway of the wireless smart sensing systems uses a different initial wireless communication channel from each other; if all of the available initial wireless communication channels have been occupied, the occupied initial wireless communication channels are also be reassigned; the reassigned initial wireless communication channels are different from each other, so that the number of paired sensor transmitters on the same initial wireless communication channel is minimized.

30. The wireless monitoring system, as recited in claim 1, wherein the pressure sensor is a pressure sensitive switch sensor that outputs a pressure sensitive switch signal, or an analog sensor that outputs an analog pressure signal.

31. The wireless monitoring system, as recited in claim 1, wherein there are a plurality of independent pressure sensors distributed at different locations of bed, and each pressure sensor independently detects pressure and outputs a pressure sensing switch signal to the communication controller of the sensor transmitter; the communication controller of the wireless sensor collects switch state data of each pressure sensor, and the switch state data are then sent to the wireless transceiver of the BLE reader through the wireless transceiver of the BLE tag of the wireless sensor at a fixed period.

32. The wireless monitoring system, as recited in claim 1, wherein the BLE reader is paired to establish wireless communication with the wireless sensor BLE tag, the patient BLE tag, and the nurse BLE tag; the BLE tag works in BLE broadcast mode to broadcast a wireless signal, and the BLE reader receives the wireless signals emitted by the BLE tag of the wireless sensor, the BLE patient tag and the BLE nurse tag; the BLE reader comprises a received signal strength indicator (RSSI), which measures the received wireless signal strength to estimate a distance between the BLE tag and the BLE reader of the sensor gateway, thus positioning the BLE tag.

33. The wireless monitoring system, as recited in claim 22, wherein when a cable between the alert device or the wireless patient station receiver and the patient station is disconnected, and when the alert device or the wireless patient station receiver is in a non-alert state, the voltage detector fails to detect the voltage between the two inputs of the patient station, the alert device or the wireless patient station receiver outputs a signal indicating an abnormal connection to the patient station, the signal is also sent to the sensor gateway or other devices connected to the sensor gateway.

34. The wireless monitoring system, as recited in claim 1, wherein when a monitored patient gets up from the wireless sensor, the wireless sensor transmitter sends a signal to the sensor gateway to trigger an alert on the sensor gateway, the alert device and a wireless smart device which displays alert information containing a risk level of the patient, enabling nurses to make appropriate responses based on the risk level.

35. The wireless monitoring system, as recited in claim 1, wherein the BLE reader comprises a received signal strength indicator (RSSI), wherein after receiving a wireless pairing signal, the BLE reader estimates a distance between the BLE tag and the BLE reader of the sensor gateway by measuring a received wireless pairing signal with the RSSI; if an estimated distance is less than or equal to a set proximity pairing distance threshold, then a proximity pairing operation is recognized as a valid operation.

36. The wireless monitoring system, as recited in claim 1, wherein when a patient is detected to be out of the ward, the sensor gateway pauses to monitor the wireless connection state between the sensor gateway and the wireless sensor; under such condition, if the BLE reader fails to receive a sensing state signal from the wireless sensor within the fixed period, the sensor gateway does not output a sensor loss alert signal to the alert device; when the patient is detected to be inside the ward, the sensor gateway monitors the wireless connection state between the sensor gateway and the wireless sensor; under such condition, if the BLE reader fails to receive a sensing state signal from the wireless sensor within the fixed period, the sensor gateway then outputs a sensor loss alert signal to the alert device.
